(19) United States
(12) Patent Application Publication
(10) Pub. No.: US 2026/0316156 A1
(43) Pub. Date: Oct. 15, 2026

(54) COPPER POWDER, COPPER PASTE CONTAINING SAME, AND METHOD FOR PRODUCING CONDUCTIVE FILM

(71) Applicant: MITSUI KINZOKU COMPANY, LIMITED, Tokyo (JP)

(72) Inventors: Mizuki AKIZAWA, Yamaguchi (JP); Hiroki SAWAMOTO, Yamaguchi (JP); Takafumi SASAKI, Yamaguchi (JP)

(21) Appl. No.: 19/109,389

(22) PCT Filed: Sep. 28, 2023
(86) PCT No.: PCT/JP2023/035411

§ 371 Date: Mar. 6, 2025

(30) Foreign Application Priority Data
Sep. 29, 2022 (JP) 2022-157049

(51) Int. Cl. B22F 1/052; B22F 1/054; B22F 1/102; C03C 17/10

(52) U.S. Cl. CPC B22F 1/052; B22F 1/056; B22F 1/102; C03C 17/10; B22F 2301/10; B22F 2302/45; B22F 2304/056; B22F 2304/058; B22F 2999/00; C03C 2217/253; C03C 2218/11

(57) ABSTRACT

A copper powder contains copper particles A and copper particles B defined below, wherein, with respect to a total of the copper particles A and the copper particles B, a content by percentage of the copper particles A is from 60 to 99 mass % and a content by percentage of the copper particles B is from 1 to 40 mass %. The copper particles A are copper particles wherein: each of the copper particles includes a core particle made from copper and a coating layer that coats a surface of the core particle; the coating layer is formed by a copper salt of an aliphatic organic acid; and a primary particle size is from 0.1 to 0.6 μm. The copper particles B are copper particles wherein: a ratio (S1/B) of a first crystallite size S1 to a BET diameter B is 0.23 or less, the first crystallite size being obtained from a full width at half maximum of a peak derived from (111) plane of copper in X-ray diffraction measurement; a ratio (S1/S2) of S1 to a second crystallite size S2 is 1.35 or less, the second crystallite size being obtained from a full width at half maximum of a peak derived from (220) plane; and a primary particle size is from 0.1 to 2.0 μm.

### CROSS REFERENCE TO RELATED APPLICATIONS

This application is a 371 U.S. National Phase of International Application No. PCT/JP2023/035411, filed on Sep. 28, 2023, which claims priority to Japanese Patent Application No. 2022-157049, filed Sep. 29, 2022. The entire disclosures of the above applications are incorporated herein by reference.

### BACKGROUND

### Technical Field

The present invention relates to a copper powder and a copper paste containing the same. The present invention also relates to a method for manufacturing a conductive film.

### Related Art

Copper is a highly conductive metal and is a highly versatile material, and is therefore widely used on an industrial scale as a conductive material. For example, copper powder, which is an aggregate of copper particles, is widely used as a raw material for manufacturing various electronic components, such as external and internal electrodes of multilayered ceramic capacitors (also referred to hereinafter as “MLCC”) and wirings for various substrates.

Applicant has previously proposed, as one such type of copper powder, a technology related to spherical copper particles whose primary particles have an average particle size from 0.1 to 0.6 μm, wherein a surface treatment agent is applied to the particle surface (see JP 2015-168878A). This technology has the advantage of achieving favorable sinterability of copper particles at low temperatures.

Unfortunately, in cases of preparing a paste with spherical copper particles and manufacturing various conductive films from the paste, the particle shape may make it difficult to ensure continuity of the conductive films.

Meanwhile, flat copper particles are also known as copper particles. Unfortunately, in cases of preparing a paste with such flat copper particles and manufacturing various conductive films from the paste, the particle shape may make it difficult to improve density of the conductive films.

So nowadays, spherical copper particles and flat copper particles are often used as a mixture with the aim of compensating for their shortcomings. In recent years, however, copper particles for manufacturing conductive films are also required to have sinterability at low temperatures, in addition to achieving continuity and density in conductive films. Low-temperature sinterability of mixed copper particles cannot be improved simply by mixing spherical copper particles and flat copper particles.

An objective of the present invention is to provide a copper powder having a low sintering temperature and capable of manufacturing a conductive film with high continuity and density.

### SUMMARY

The present invention provides A copper powder comprising copper particles A and copper particles B defined below, wherein:
with respect to a total of the copper particles A and the copper particles B, a content by percentage of the copper particles A is from 60 to 99 mass % and a content by percentage of the copper particles B is from 1 to 40 mass %;
the copper particles A are copper particles wherein
   each of the copper particles includes a core particle made from copper and a
   coating layer that coats a surface of the core particle,
   the coating layer is formed by a copper salt of an aliphatic organic acid, and
   a primary particle size is from 0.1 to 0.6 μm; and
the copper particles B are copper particles wherein
   a ratio (S1/B) of a first crystallite size S1 to a BET diameter B is 0.23 or less, the first crystallite size being obtained using Scherrer equation from a full width at half maximum of a peak derived from (111) plane of copper in X-ray diffraction measurement, and the BET diameter B being calculated from a BET specific surface area,
   a ratio (S1/S2) of the first crystallite size S1 to a second crystallite size S2 is 1.35 or less, the second crystallite size being obtained using the Scherrer equation from a full width at half maximum of a peak derived from (220) plane of copper in X-ray diffraction measurement, and a primary particle size is from 0.1 to 2.0 μm.

### DETAILED DESCRIPTION

Hereinafter, the present invention will be described according to preferred embodiments thereof. A copper powder of the present invention contains the following copper particles A and copper particles B.

### {Copper Particles A}

The copper particles A are copper particles wherein:
each of the copper particles includes a core particle made from copper and a coating layer that coats a surface of the core particle;
the coating layer is formed by a copper salt of an aliphatic organic acid; and
a primary particle size is from 0.1 to 0.6 μm.

### {Copper Particles B}

The copper particles B are copper particles wherein:
a ratio (S1/B) of a first crystallite size S1 to a BET diameter B is 0.23 or less, the first crystallite size being obtained using Scherrer equation from a full width at half maximum of a peak derived from (111) plane of copper in X-ray diffraction measurement, and the BET diameter B being calculated from a BET specific surface area;
a ratio (S1/S2) of the first crystallite size S1 to a second crystallite size S2 is 1.35 or less, the second crystallite size being obtained using the Scherrer equation from a full width at half maximum of a peak derived from (220) plane of copper in X-ray diffraction measurement;
a primary particle size is from 0.1 to 2.0 μm; and
copper particles that fall under the copper particles A are excluded.

The present Inventors have conducted in-depth studies to find that, surprisingly, a copper powder containing the aforementioned copper particles A and B has a low sintering temperature, and a conductive film manufactured from a copper paste containing the copper powder has high continuity and density.

From the viewpoint of further improving the aforementioned effects, the copper particles A preferably have a spherical shape, whereas the copper particles B preferably have a flat shape.

From the viewpoint of achieving both an improvement in sinterability, at low temperatures, of the copper powder of the present invention and an improvement in conductivity of the conductive film obtained by sintering the particles, it is preferable that an average image-analysis diameter of primary particles of the copper particles A is preferably from 0.1 to 0.6 μm, more preferably from 0.12 to 0.4 μm, even more preferably from 0.15 to 0.3 μm. Herein, the term “primary particle” means an object that is regarded as the smallest unit of particle as determined from its external geometrical form.

From the same viewpoint, an average image-analysis diameter of primary particles of the copper particles B is preferably from 0.1 to 2.0 μm, more preferably from 0.15 to 1.0 μm, even more preferably from 0.2 to 0.6 μm.

Further, the particle size of the copper particles A as calculated from a BET specific surface area (also referred to hereinafter as “BET diameter A”) is preferably from 0.1 to 0.6 μm, more preferably from 0.12 to 0.4 μm, even more preferably from 0.15 to 0.3 μm. When the BET diameter A is within the aforementioned range, it is possible to improve the thermal conductivity of the copper powder of the present invention and effectively lower the sintering temperature.

From the same viewpoint, the particle size of the copper particles B as calculated from a BET specific surface area (also referred to hereinafter as “BET diameter B”) is preferably from 0.1 to 2.0 μm, more preferably from 0.15 to 1.0 μm, even more preferably from 0.2 to 0.6 μm. When the BET diameter B is within the aforementioned range, it is possible to improve the thermal conductivity of the copper powder of the present invention and effectively lower the sintering temperature.

Herein, “BET diameter B” is also referred to as “primary particle size of the copper particles B”.

The average image-analysis diameter of primary particles of the copper particles A and B can be obtained by: observing the copper particles using, for example, a scanning electron microscope (JSM-6330F manufactured by JEOL Ltd.) at a magnification of 10000 times or 30000 times; measuring the maximum Ferret diameter in the horizontal direction with respect to 200 particles in the visual field; and calculating a sphere-equivalent volume average particle size from the measured values.

Herein, the average image-analysis diameter of primary particles of the copper particles A calculated as above is also referred to as “primary particle size of the copper particles A”.

The BET diameter A and BET diameter B as calculated from the BET specific surface area can be measured under the following conditions based on the BET method. More specifically, the size can be measured according to the nitrogen adsorption method using “Macsorb” manufactured by Mountech Co., Ltd. The amount of powder to be measured is set to 0.2 g and the pre-degassing condition is set to 80° C. for 30 minutes under vacuum. The BET diameter A, as well as BET diameter B, is calculated from the measured BET specific surface area using Formula (I) below.

In Formula (I), d is the BET diameter A or BET diameter B [μm], A_{BET} is the specific surface area [m²/g] measured by the BET single-point method, and p is the density of copper [g/cm³].

d=6/(A_{BET}×ρ) (I)

Preferred embodiments of the copper particles A and B will be described in further detail below.

### Preferred Embodiment of Copper Particles A:

In the copper particles A, a surface treatment agent containing a copper salt of an aliphatic organic acid is applied to the surface of the particles. Thus, a coating layer made from the surface treatment agent is formed so as to cover, continuously or discontinuously, the surface of core particles made from copper. The surface treatment agent is used to suppress both oxidation of copper and aggregation of particles.

Preferably, the core particles are made only of copper and residual unavoidable impurities.

As described above, the surface treatment agent used in the present invention contains a copper salt of an aliphatic organic acid.

In the present technical field, a surface treatment agent, such as a fatty acid or a fatty acid amine, has been used to suppress both the oxidation of copper in copper particles and the aggregation of the particles. However, such a treatment agent has a high decomposition temperature, and there are cases where the treatment agent cannot be sufficiently removed during sintering of the copper particles. This may lead to an increase in the sintering start temperature and an increase in the resistance of a conductive film obtained after the copper particles have been sintered together. The present Inventors have conducted in-depth studies to address this problem, and found that the use of a copper salt of an aliphatic organic acid as the surface treatment agent can lower the sintering start temperature while suppressing both the oxidation of copper and the aggregation of particles, and can consequently lower the resistance of the conductive film obtained after sintering while improving low-temperature sinterability of the particles.

From the viewpoint of suppressing both the oxidation of copper and the aggregation of particles while lowering the sintering temperature of the copper powder of the present invention, the aliphatic organic acid constituting the copper salt of the aliphatic organic acid has preferably from 6 to 18 carbon atoms, more preferably from 8 to 18 carbon atoms, even more preferably from 10 to 18 carbon atoms, further more preferably from 12 to 18 carbon atoms. Examples of such aliphatic organic acid may include linear/branched saturated/unsaturated carboxylic acids, sulfonic acids having linear/branched saturated/unsaturated hydrocarbon groups, and the like, and preferable examples are linear saturated/unsaturated carboxylic acids. Also, copper in the copper salt of the aliphatic organic acid has a valency of 1 or 2, and preferably 2.

Concrete examples of the carboxylic acid may include citric acid, hexanoic acid, heptanoic acid, octanoic acid, nonanoic acid, decanoic acid, lauric acid, palmitic acid, oleic acid, stearic acid, and the like. Lauric acid, oleic acid, and stearic acid are preferable, and lauric acid and stearic acid are more preferable.

Concrete examples of the sulfonic acid may include hexane sulfonic acid, heptane sulfonic acid, octane sulfonic acid, nonane sulfonic acid, decane sulfonic acid, lauric sulfonic acid, palmitic sulfonic acid, oleic sulfonic acid, stearic sulfonic acid, and the like. One of these aliphatic organic acids may be used alone, or two or more thereof may be used in combination.

The surface treatment agent can be applied to the particle surface, for example, in a step after core particles made from copper have been produced, by bringing the obtained core particles into contact with the copper salt of the aliphatic organic acid, which is the surface treatment agent. The amount of application of the surface treatment agent is, when expressed as the ratio (mass %) of the entire surface treatment agent to the copper particles A in a state where the surface treatment agent has been applied, preferably from 0.2 to 2.0 mass %, more preferably from 0.3 to 1.0 mass %, in terms of carbon atoms. When the amount of the surface treatment agent applied is within the aforementioned range, the melting temperature of the copper particles can be lowered by the effects of co-melting and the removal of an oxide film on the surface of the copper particles by the surface treatment agent, and consequently, the sintering temperature can be lowered.

The ratio (mass %) of the surface treatment agent applied to the surface of the copper particles A can be determined in the following manner: 0.5 g of copper powder, which is an aggregate of the copper particles A to which the surface treatment agent has been applied, is heated in an oxygen stream in a carbon and sulfur analyzer (EMIA-320V, manufactured by HORIBA, Ltd.) to decompose the carbon component in the copper powder into CO or CO₂, and the amount of CO or CO₂ is quantified, to calculate the ratio of the surface treatment agent.

Qualitative and quantitative analysis of the surface treatment agent can be performed using such methods as, for example, nuclear magnetic resonance (NMR), Raman spectroscopy, infrared spectroscopy, liquid chromatography, time-of-flight secondary ion mass spectrometry (TOF-SIMS), etc., either alone or in combination.

The copper particles A have, on the surface of the core particles, the coating layer that is formed using the copper salt of the aliphatic organic acid as the surface treatment agent. Whether or not the coating layer has been formed using the copper salt of the aliphatic organic acid can be determined using the following method, for example. More specifically, a measurement sample is prepared by mixing, in a mortar, the copper particles A with KBr such that the mass of the copper particles is 5 mass %, and the measurement sample is then measured by a diffuse reflection method using an infrared spectrophotometer (model No.: FT-IR4600) manufactured by JASCO Corporation under the conditions of a resolution of 4 cm⁻¹ and a number of scans of 128 times, to thereby obtain a graph (spectrum) with the Kubelka-Munk transformed absorbance on the vertical axis and the wave number (500 to 4000 cm⁻¹) on the horizontal axis. At this time, if an infrared absorption peak is observed in a range of 1504 to 1514 cm⁻¹, and no peak is observed in a range of 1584 to 1596 cm⁻¹, it can be determined that the coating layer has been formed using the copper salt of the aliphatic organic acid. In other words, it is preferable that, when measured by infrared spectroscopy, the copper particles A have an infrared absorption peak observed in the range of 1504 to 1514 cm⁻¹ and no infrared absorption peak observed in the range of 1584 to 1596 cm⁻¹.

“Having an infrared absorption peak” is defined in the following manner. First, IR spectral data normalized by the maximum value of a peak observed in a range of 2910 to 2940 cm⁻¹ is differentiated twice, and waveform separation is performed in a range of 1500 to 1600 cm⁻¹ based on a zero up-crossing method. Subsequently, the arithmetic mean value is calculated from the absolute values of the amplitude from a reference line (zero) of separated waveforms. If the absolute value of the peak height is greater than half of the arithmetic mean value, the copper particles are regarded as “having an infrared absorption peak”.

Note that, in the case of copper particles in which a fatty acid or an aliphatic amine is used as a surface treatment agent, an infrared absorption peak is detected in the range of 1584 to 1596 cm⁻¹, and therefore, such copper particles can be distinguished from the copper particles A in this respect.

Although it is not clear why the use of a copper salt of an aliphatic organic acid makes it possible to obtain copper particles capable of lowering the sintering temperature of the copper powder of the present invention while suppressing both the oxidation of copper and the aggregation of particles, the present Inventors infer that the reason is as follows.

As described above, the copper particles of the present invention and copper particles in which a fatty acid or an aliphatic amine is used as a surface treatment agent differ from each other in terms of the presence or absence of an infrared absorption peak at a specific wave number.

Infrared spectroscopy is based on the measurement principle of measuring the absorption of light energy corresponding to the kinetic energy of bonds in a molecule by irradiating a substance or molecule to be measured with infrared radiation. In general, if infrared absorption is observed in infrared spectroscopy, it indicates the presence of a certain bond in a molecule. In particular, if infrared absorption is observed at a high wave number position, it can be said that a bond with high binding energy is present in a molecule because infrared radiation with a high wave number has high energy.

A comparison between the copper particles A and copper particles in which a fatty acid or an aliphatic amine is used as a surface treatment agent shows that, for both types of copper particles, infrared absorption is observed in a low wave number region in the range of 1504 to 1514 cm⁻¹, and therefore, it is inferred that absorption in this region indicates the presence of a coating layer bonded to the core particle surface. It is conceivable that this is why both the oxidation of copper in the core particles and the aggregation of particles can be suppressed.

On the other hand, when focusing on the high wave number region in the range of 1584 to 1596 cm⁻¹, the copper particles A do not exhibit infrared absorption in this high wave number region, whereas the copper particles in which a fatty acid or an aliphatic amine is used as a surface treatment agent exhibit infrared absorption in this high wave number region. This means that, when compared with copper particles in which a fatty acid or an aliphatic amine is used as a surface treatment agent, the copper particles of the present invention have fewer bonds with high binding energy within a molecule. This can be interpreted to indicate that, in the copper particles of the present invention, the bond between the surface treatment agent and the core particles is relatively weak, and it is therefore conceivable that the surface treatment agent is easily desorbed at a low temperature, enabling the particles to be sintered together at a low temperature.

For the reasons described above, it is conceivable that, by applying the present surface treatment agent, which contains a copper salt of an aliphatic organic acid, to the surface of the copper particles A, it is possible to lower the sintering temperature while suppressing both the oxidation of copper and the aggregation of particles.

Furthermore, with respect to the copper particles A, in order to identify which organic acid is the aliphatic organic acid constituting the copper salt of the aliphatic organic acid, an analysis can be performed by TOF-SIMS, for example.

From the viewpoint of further lowering the sintering temperature of the copper powder of the present invention, it is preferable that, in a thermogravimetric analysis when the copper particles A are heated from 25° C. to 1000° C., the temperature at which the percentage of the mass loss value is 10% of the mass loss value at 500° C. is preferably from 150° C. to 220° C., and more preferably from 180° C. to 220° C.

The aforementioned thermogravimetric analysis can be performed in the following manner, for example. That is, the mass loss ratio when 50 mg of a measurement sample is heated from 25° C. to 1000° C. is measured by using TG-DTA2000SA manufactured by Bruker AXS. The atmosphere is nitrogen, and the temperature increase rate is 10° C./min. The temperature at which the mass loss ratio reaches a predetermined percentage can be used as an indicator of the low-temperature sinterability of the copper particles A, because the lower this temperature is, the lower the temperature at which the aliphatic organic acid forming the coating layer can be removed.

As described above, it is preferable that the shape of the copper particles A is spherical. In order to obtain spherical copper particles A, for example, spherical core particles can be used. Note that “spherical particles” refer to particles having a circularity coefficient of preferably 0.85 or greater, more preferably 0.90 or greater, as measured using the following method. The circularity coefficient is calculated using the following method. A scanning electron microscope image of metal particles is captured, and 1000 particles that do not overlap each other are randomly chosen. When the area of a two-dimensional projected image of a particle is defined as S, and the perimeter of the particle is defined as L, the circularity coefficient of the particle is calculated from the expression 4πS/L². The arithmetic mean value of the circularity coefficients of the individual particles is used as the aforementioned circularity coefficient. If the two-dimensional projected image of a particle is a perfect circle, the circularity coefficient of the particle is 1.

### Preferred Embodiment of Copper Particles B:

In the copper particles B, there is a predetermined relationship between crystallite sizes at specific crystal planes calculated from X-ray diffraction measurement. More specifically, when the particle size calculated from the BET specific surface area is defined as BET diameter B and the crystallite size obtained using the Scherrer equation from a diffraction peak derived from a (111) plane of copper in X-ray diffraction measurement is defined as first crystallite size S1, a ratio (S1/B) of the first crystallite size S1 to the BET diameter B is preferably 0.23 or less, more preferably from 0.02 to 0.23, even more preferably from 0.05 to 0.23.

The diffraction peak derived from the (111) plane of copper is a peak with the greatest height in an X-ray diffraction pattern obtained through X-ray diffraction measurement of the copper particles B. Therefore, the first crystallite size is larger than crystallite sizes calculated from the diffraction peaks derived from other crystal planes, and is also considered to be representative of crystallinity. Thus, due to the configuration that the first crystallite size S1 is small relative to the BET diameter B, it is inferred that there are many crystal grain boundaries in a single particle. As a result, the thermal energy applied when the particles are heated is likely to destabilize the crystallite interfaces, resulting in active atomic diffusion, enhancing the fusion between particles at a low temperature, and thus lowering the sintering temperature.

Such copper particles can be obtained using a manufacturing method described below, for example.

The first crystallite size S1 of the copper particles B is preferably from 10 to 80 nm, more preferably from 20 to 75 nm, even more preferably from 25 to 70 nm. When the crystallite size S1 is within this range, it is possible to facilitate the formation of even more crystal grain boundaries in a single particle, which further enhances the fusion of particles during heating and effectively lowers the sintering temperature.

Furthermore, in the copper particles B, when the crystallite size obtained using the Scherrer equation from a full width at half maximum of a peak derived from a (220) plane of copper in X-ray diffraction measurement is defined as second crystallite size S2, a ratio (S1/S2) of the first crystallite size S1 to the second crystallite size S2 is preferably less than or equal to a predetermined value.

More specifically, the S1/S2 ratio is preferably 1.35 or less, more preferably from 0.1 to 1.3, even more preferably from 0.1 to 1.2.

Since metallic copper tends to have a face-centered cubic crystal structure, the copper particles B each have a (111) plane of copper on a specific face of the particle surface and a copper (220) plane on a face that intersects the (111) plane. A smaller S1/S2 ratio indicates that the copper particles are not growing in the (111) plane direction or are growing in the (220) plane direction. Therefore, the fact that S1/S2 is within the aforementioned predetermined range is generally correlated with the fact that the copper particles B each have an anisotropic particle shape such as a flat shape. “Flat shape” refers to a shape having a pair of principal faces that oppose one another and side faces that intersect these principal faces. In cases where each copper particle B has a flat shape, it is inferred that the (111) plane of copper exists on a principal face of the copper particle B and the (220) plane of copper exists on a side face of the copper particle B.

Therefore, when the S1/S2 ratio is within the aforementioned range, the principal faces of the copper particles B, or the side faces of the particles, are more likely to contact one another when the copper particles B are aligned at the time of sintering, and thus, the contact areas between the copper particles B are more likely to be the same crystal plane. Compared to cases where particles contact one another on different crystal faces, in cases where particles contact one another on the same crystal face, the particles, when applied with thermal energy, are more likely to have higher thermal energy utilization efficiency, and atoms at the crystallite interface are more easily diffused. As a result, fusion between particles at a low temperature can be enhanced, and thus, the sintering temperature of the copper powder can be lowered. This is advantageous in that the sinterability can be further improved compared with spherical particles or mechanically manufactured flat copper particles.

Further, since the copper particles B are likely to contact one another by face-to-face contact as described above, the area of contact becomes larger compared to spherical copper particles etc. Thus, a conductive film manufactured from the copper powder of the present invention, containing the copper particles B, will have high continuity.

Such copper particles can be obtained using the manufacturing method described below, for example.

The second crystallite size S2 of the copper particles B is preferably from 10 to 80 nm, more preferably from 20 to 75 nm, even more preferably from 30 to 70 nm. When the crystallite size S2 is within this range, it is possible to form many conductive paths owing to the shape of the copper particles while improving the low-temperature sinterability resulting from the relatively small crystallite size, thereby enabling formation of a low-resistance conductive film after sintering.

In the copper particles B, when the crystallite size obtained using the Scherrer equation from a full width at half maximum of a peak derived from a (311) plane of copper in X-ray diffraction measurement is defined as third crystallite size S3, a ratio (S1/S3) of the first crystallite size S1 to the third crystallite size S3 is preferably less than or equal to a predetermined value.

More specifically, the S1/S3 ratio is preferably 1.35 or less, more preferably from 0.20 to 1.30, even more preferably from 0.50 to 1.25.

Since metallic copper tends to have a face-centered cubic crystal structure, the copper particles B each have a (111) plane of copper on a specific face of the particle surface and a copper (311) plane on a face that intersects the (111) plane. A smaller S1/S3 ratio indicates that the copper particles B are not growing in the (111) plane direction or are growing in the (311) plane direction. Therefore, the fact that S1/S3 is within the aforementioned predetermined range is generally correlated with the fact that the copper particles B each have an anisotropic particle shape such as a flat shape. In this case, it is inferred that the (111) plane of copper exists on a principal face of the copper particle B and the (311) plane of copper exists on a side face of the copper particle.

Therefore, when the S1/S3 ratio is within the aforementioned range, the principal faces of the copper particles B, or the side faces of the copper particles B, are more likely to contact one another when the copper particles B are aligned at the time of sintering, and thus, the contact areas between the copper particles B are more likely to be the same crystal plane. As a result, when the copper powder of the present invention is heated, atomic diffusion at the crystallite interfaces of the copper particles B becomes active, and thus the fusion between particles at a low temperature can be enhanced, and the sintering temperature of the copper powder can be lowered. This is advantageous in that the sinterability can be further improved compared with spherical particles or mechanically manufactured flat copper particles.

Such copper particles can be obtained using the manufacturing method described below, for example.

The third crystallite size S3 of the particles B is preferably from 10 to 80 nm, more preferably from 20 to 75 nm, even more preferably from 30 to 70 nm. When the crystallite size S3 is within this range, it is possible to form many conductive paths owing to the shape of the copper particles B while improving the low-temperature sinterability resulting from the relatively small crystallite size, thereby enabling formation of a low-resistance conductive film after sintering.

The first crystallite size S1, the second crystallite size S2, and the third crystallite size S3 can be calculated using the Scherrer equation below respectively from the full widths at half maximum of diffraction peaks derived from the (111), (220) and (311) planes of copper obtained in X-ray diffraction measurement. The conditions of the X-ray diffraction measurement are described in detail in the Examples below. PDF number 00-004-0836 is used.

$$Scherrer equation : = K λ / β cos θ$$

D: Crystallite size
K: Scherrer's constant (0.94)
λ: X-ray wavelength
β: Full width at half maximum [rad]
θ: Diffraction angle

It is preferable that the copper particles B mainly contain a copper element. The phrase “mainly contain a copper element” means that the content of the copper element in the copper particles is 97.0 mass % or greater, preferably 97.5 mass % or greater, more preferably 98.0 mass % or greater, even more preferably 98.5 mass % or greater. The content of the copper element can be measured using ICP optical emission spectrometry, for example.

The copper particles B contain a copper element and elements other than the copper element, or are constituted by a copper element and do not contain elements other than the copper element except for unavoidable impurities. It is acceptable for the copper particles B to contain trace amounts of unavoidable impurity elements such as an oxygen element, as long as the effects of the present invention are not impaired. In either form, the content of elements other than the copper element in the copper particles is preferably 1.5 mass % or less. The content of these elements can be measured using ICP optical emission spectrometry, for example.

It is also preferable that, in the copper particles B, the content of the carbon element contained in the particles is small. More specifically, the carbon element content in the copper particles B is preferably 5000 ppm or less, more preferably 4500 ppm or less, even more preferably 4000 ppm or less. The smaller the content, the better, but the realistic content is 100 ppm or greater. When the content of the carbon element is within this range, it is possible to relatively suppress sintering inhibition caused by organic matters on the surface of the copper particles. Such copper particles can be manufactured using the manufacturing method described below, for example.

The content of the carbon element can be measured using such methods as gas analysis or combustion carbon analysis, for example. In measuring the content of the carbon element, it is first determined whether or not the surface of the copper particles B has been coated. This can be verified using such methods as, for example, X-ray photoelectron spectroscopy (XPS), nuclear magnetic resonance (NMR), Raman spectroscopy, infrared spectroscopy, liquid chromatography, time-of-flight secondary ion mass spectrometry (TOF-SIMS), etc., either alone or in combination. If it is determined, through one or more of these methods, that the particle surface has been subjected to a coating treatment, then qualitative and quantitative analysis is performed to determine the type and amount of elements contained in the coating layer formed by the coating treatment, by employing one or more of the aforementioned methods. In addition to this, thermogravimetry (TG) can be used to measure the change in mass that occurs before and after the firing temperature and the amount of carbon after heating to that temperature, thereby evaluating the physical properties of the organic matters.

If it is determined that the particle surface has not been subjected to a coating treatment, then the copper particles B to be measured are subjected directly to measurement, and the obtained quantitative value is found as the carbon element content in the copper particles B.

It is also preferable that, in the copper particles B, the content of a phosphorus element contained in the particle is within a predetermined range. More specifically, the phosphorus element content in the copper particles is preferably 300 ppm or greater, more preferably from 300 to 1500 ppm, even more preferably from 300 to 1000 ppm. When the phosphorus element content is within this range, it is possible to lower the melting point, thereby further lowering the sintering temperature, while sufficiently maintaining the conductivity of copper. Such copper particles can be manufactured using the manufacturing method described below, for example. The presence and content of phosphorus elements in the copper particles B can be measured using ICP optical emission spectrometry, for example.

As described above, the smaller the content of carbon in the copper particles B is, the less likely that sintering inhibition will occur, thus enabling sintering of the copper powder at low temperatures. Note, however, that as long as the carbon element content is within the aforementioned range, it is possible to relatively suppress sintering inhibition caused by organic matters on the surface of the copper particles B; therefore, organic matters may intentionally be applied to the surface of the copper particles B.

Examples of organic matters to be applied to the surface of the copper particles B may include various fatty acids, copper salts of aliphatic organic acids, and aliphatic amines. Applying such organic matters to the surface of the copper particles B can suppress aggregation of the copper particles. Particularly, from the viewpoint of improving the copper powder's low-temperature sinterability, it is preferable to use aliphatic amines or saturated/unsaturated fatty acids having from 6 to 18 carbon atoms, more preferably from 10 to 18 carbon atoms. Concrete examples of such fatty acids and aliphatic amines may include benzoic acid, pentanoic acid, hexanoic acid, octanoic acid, nonanoic acid, decanoic acid, lauric acid, palmitic acid, oleic acid, stearic acid, pentylamine, hexylamine, octylamine, decylamine, laurylamine, oleylamine, stearylamine, etc. One of these fatty acids or aliphatic amines may be used alone, or two or more thereof may be used in combination.

As long as the effects of the present invention are achieved, there is no particular limitation to the shape of the copper particles B, but the particles preferably have a flat shape when manufactured using the method described below. Such particles each have a plate-like shape with a pair of substantially flat principal faces that oppose one another and side faces that intersect these principal faces, wherein the maximum length of the principal faces is greater than the thickness. In this case, it is also preferable that, when the principal face of the copper particle B is viewed in a planar view, the shape has a contour defined by a combination of straight lines or a combination of straight and curved lines.

A conductive film manufactured from a copper paste containing the copper powder of the present invention has high density and continuity. From the viewpoint of further increasing the conductive film's density and continuity, it is preferable that the content by percentage of the copper particles A to the total of the copper particles A and the copper particles B is from 60 to 99 mass %, more preferably from 65 to 88 mass %, even more preferably from 70 to 85 mass %.

From the same viewpoint, it is preferable that the content by percentage of the copper particles B to the total of the copper particles A and the copper particles B is from 1 to 40 mass %, more preferably from 12 to 35 mass %, even more preferably from 15 to 30 mass %.

Next, suitable methods for manufacturing the copper powder of the present invention will be described. The copper powder of the present invention can suitably be manufactured by mixing the copper particles A and the copper particles B at the aforementioned preferable ratio. Hereinbelow, suitable methods for manufacturing the copper particles A and the copper particles B, as well as methods for mixing the copper particles A and the copper particles B, will be described in detail in order.

### Method for Manufacturing Copper Particles A:

First, a suitable method for manufacturing the copper particles A will be described. The present manufacturing method includes bringing core particles made from copper into contact with a solution containing a copper salt of an aliphatic organic acid, to thereby form a coating layer that coats the surface of the core particles.

First, core particles made of copper are prepared prior to surface treatment with a copper salt of an aliphatic organic acid. As for the method for manufacturing core particles made of copper, core particles can be manufactured using, for example, a wet method disclosed in JP 2015-168878A. More specifically, first, a reaction solution is prepared, the reaction solution containing a monovalent or divalent copper source, such as copper chloride, copper acetate, copper hydroxide, copper sulfate, copper oxide, cuprous oxide, etc., in a liquid medium containing water and preferably a monohydric alcohol having 1 to 5 carbon atoms. This reaction solution is mixed with hydrazine at a ratio preferably from 0.5 to 50 mol with respect to 1 mol of copper, and the copper source is reduced, to obtain core particles made of copper. The core particles obtained using this method do not have a surface treatment agent, such as a copper salt of an aliphatic organic acid, applied to the surface thereof, and have a small particle size.

Preferably, the core particles obtained through the aforementioned process are washed. Examples of the washing method may include decantation, rotary filtering, and the like. Washing of the core particles by rotary filtering may involve, for example: preparing an aqueous slurry in which the core particles are dispersed in a solvent, such as water; and washing the same until the conductivity of the slurry reaches, preferably, 2.0 mS or less. In this case, the washing conditions can be set as follows: when, for example, water is used as a washing solvent, the washing temperature is from 15° C. to 30° C., and the washing time is from 10 to 60 minutes. When the conductivity of the slurry is within the aforementioned range, it is possible to perform surface treatment (described later) with high efficiency while keeping the core particles being washed in a uniformly-dispersed state without causing aggregation. The content by percentage of the copper-made core particles in this slurry is preferably from 5 to 50 mass %, from the viewpoint of improving both the washing efficiency and the dispersibility of the particles.

Alternatively, instead of the aforementioned method, for example, a direct current thermal plasma (DC plasma) method disclosed in WO 2015/122251 may be used as another method for manufacturing core particles made of copper. More specifically, core particles can be produced from a copper matrix powder by subjecting the matrix powder to the direct current thermal plasma method, which is a type of PVD. The core particles obtained using this method also do not have a surface treatment agent, such as a copper salt of an aliphatic organic acid, applied to the surface thereof, and have a small particle size. If necessary, the obtained core particles may be crushed or classified to separate or remove coarse particles and microparticles.

Next, the core particles obtained using the aforementioned method are surface-treated with a surface treatment agent to form a coating layer that coats the surface of the core particles. As for the surface treatment method, for example, it is possible to employ a method wherein the core particles are brought into contact with a solution in which a copper salt of an aliphatic organic acid is dissolved in a solvent. The core particles that are brought into contact with the copper salt of the aliphatic organic acid in this step may be in the form of an aqueous slurry in which the core particles are dispersed in a solvent such as water, or may be in a dry state without being dispersed in a solvent etc. With regard to the order of contact in this step, one of either the core particles or the solution of the copper salt of the aliphatic organic acid may be added to the other, or the core particles and the solution of the copper salt of the aliphatic organic acid may be brought into contact at the same time.

From the viewpoint of enabling the core particles to be uniformly surface-treated with the copper salt of the aliphatic organic acid, it is preferable to use a method in which a solution of the copper salt of the aliphatic organic acid is added to a slurry in which the core particles are dispersed.

A method of performing surface treatment by adding the core particles to a solution of the copper salt of the aliphatic organic acid will be described below by way of example. First, a solvent to be used for the solution of the copper salt of the aliphatic organic acid is heated to a temperature (e.g., a temperature from 25° C. to 80° C.) that is equal to or lower than the boiling point of the solvent used, and in this state, the copper salt of the aliphatic organic acid is added to the solvent, to prepare a solution of the copper salt of the aliphatic organic acid. Next, while the temperature of the copper salt solution is kept at or above the melting point of the copper salt of the aliphatic organic acid, dry-state core particles, or a slurry containing the copper particles, is added to the solution of the copper salt of the aliphatic organic acid and then stirred for 1 hour, to thereby apply surface treatment to the surface of the core particles. In the resulting copper particles A obtained using this method, a coating layer made from the copper salt of the aliphatic organic acid is formed on the surface of the core particles made of copper. In the case where surface treatment is performed using a slurry containing the core particles, it is preferable that the slurry is heated to a temperature that is equal to or higher than the melting point of the copper salt of the aliphatic organic acid, from the viewpoint of uniformly forming the coating layer on the surface of the core particles.

In the surface treatment using the solution of the copper salt of the aliphatic organic acid, the content of the copper salt of the aliphatic organic acid in the reaction solution containing the core particles is preferably from 0.1 to 3.0 parts by mass, more preferably from 0.2 to 2.0 parts by mass, with respect to 100 parts by mass of the core particles that have not been surface-treated. By performing surface treatment according to this amount, it is possible to obtain copper particles A that have been surface-treated according to the aforementioned carbon atom ratio.

Examples of the solvent in which the copper salt of the aliphatic organic acid is dissolved may include organic solvents such as monohydric alcohols having 1 to 5 carbon atoms, polyhydric alcohols, esters of polyhydric alcohols, ketones, ethers, and the like. Among these, in view of compatibility with water, economy, handleability, and ease of removal, it is preferable to use a monohydric alcohol having 1 to 5 carbon atoms, and it is more preferable to use an aqueous methanol solution, ethanol, 1-propanol, or isopropyl alcohol.

The copper particles A obtained through the aforementioned process may be subjected to washing and solid-liquid separation if necessary, and after that, the copper particles A may be mixed with the copper particles B in the form of a slurry in which they are dispersed in a solvent such as water or an organic solvent, or the copper particles A may be dried and be mixed with the copper particles B in the form of a dry powder, which is an aggregate of the copper particles. In either case, the inclusion of the copper particles A in the copper powder of the present invention offers an excellent copper powder having a low sintering temperature while being suppressed in terms of oxidation of copper, i.e., the constituent metal, and also suppressed in terms of aggregation of particles.

### Method for Manufacturing Copper Particles B:

Next, a suitable method for manufacturing the copper particles B will be described. This manufacturing method has two reduction steps including: a first reduction step of reducing copper ions, to thereby produce cuprous oxide; and a second reduction step of reducing the cuprous oxide in the presence of a polyphosphoric acid including two or more phosphoric acid units or a salt thereof (hereinafter collectively referred to as “polyphosphoric acid substance”), to thereby produce copper particles.

The polyphosphoric acid substance is caused to be present in a reaction system during or before the second reduction step. That is to say, the polyphosphoric acid substance may be caused to be present in a reaction system during or before the first reduction step, and the second reduction step may be performed in that state. Alternatively, the polyphosphoric acid substance may not be present in a reaction system in the first reduction step, and may be caused to be present in the reaction system after the first reduction step and during or immediately before the second reduction step.

In this manufacturing method, from the viewpoint of achieving uniform control of the reduction reaction, improvement of productivity of the resulting copper particles, and lower production cost, it is preferable to perform both reduction steps under wet conditions in which reduction is performed in an aqueous solution, and it is also preferable to perform both reduction steps in the same reaction system. The following is an example of a manufacturing method using the same reaction system under wet conditions.

First, a reaction solution containing a copper source and a reducing compound is prepared, and the first reduction step is performed to reduce copper ions to produce cuprous oxide in the solution. The reaction solution may be prepared by adding the raw materials to the solvent simultaneously or by adding the raw materials to the solvent in any order.

From the viewpoint of facilitating the control of the reduction reaction of copper ions and improving handleability during the manufacture, it is preferable to pre-mix the copper source and solvent to form a copper-containing solution, and then add, to the copper-containing solution, a solid-form reducing compound or a reducing compound solution in which the reducing compound is dissolved in advance in a solvent. The reducing compound may be added in a batch or sequentially.

In the first reduction step, the polyphosphoric acid substance may or may not be contained in the reaction solution as described above. If the polyphosphoric acid substance is present in the reaction solution, it is preferable to add the copper source, the polyphosphoric acid substance, and the reducing compound in that order to effectively control the reduction of copper ions using the reducing compound and the crystal growth.

Examples of the solvent to be used in the reaction solution may include water and lower alcohols, such as methanol, ethanol, and propanol. One of these solvents may be used alone, or two or more thereof may be used in combination.

The copper source used in the first reduction step may be a compound that produces copper ions in the reaction solution, and water-soluble copper compounds are preferred. Concrete examples of such copper sources may include copper organic acid salts such as copper formate, copper acetate, and copper propionate, copper inorganic acids such as copper nitrate and copper sulfate, and other various copper compounds. These copper compounds may be anhydrous or hydrated. One of these copper compounds may be used alone, or two or more thereof may be used in combination.

The content of the copper source in the reaction system in the first reduction step is preferably from 0.01 to 2.0 mol/L, more preferably from 0.1 to 1.5 mol/L, when expressed as the molar concentration of the copper element. When the content is within this range, it is possible to manufacture, with high productivity, copper particles with a small particle size and a small crystallite size on a specific crystal plane.

The reducing compound is preferably a water-soluble compound. Concrete examples of the reducing compound may include hydrazine compounds such as hydrazine, hydrazine hydrochloride, hydrazine sulfate, and hydrazine hydrate, boron compounds and their salts such as sodium borohydride and dimethylamine borane, sulfur oxoacid salts such as sodium sulfite, sodium hydrogen sulfite, and sodium thiosulfate, nitrogen oxoacid salts such as sodium nitrite and sodium hyponitrite, and oxoacids of phosphorous and their salts such as phosphorous acid, sodium phosphite, hypophosphorous acid, and sodium hypophosphite. These reducing compounds may be anhydrous or hydrated. One of these reducing compounds may be used alone, or two or more thereof may be used in combination.

From the viewpoint of facilitating the control in the first reduction step such that the reduction product becomes cuprous oxide, thereby facilitating the control of the copper particle growth in the subsequent reduction step to obtain particles with a predetermined crystallite size, and from the viewpoint of suppressing unintended inclusion of impurities such as carbon elements after the reduction, it is preferable to use a hydrazine compound, and more preferable to use an anhydride or hydrate of hydrazine, as the reducing compound in the reducing solution.

The content of the reducing compound in the reaction solution in the first reduction step is preferably from 0.1 to 2 mol, more preferably from 0.1 to 1 mol, with respect to 1 mol of copper element. When the concentration of the reducing compound is controlled to be within this range, it is possible to control the progress of the reduction reaction of copper ions and the grain growth as appropriate, and thus manufacture, with high productivity, copper particles with a small particle size and a small crystallite size on a specific crystal plane.

The reaction solution in the first reduction step is preferably acidic with a pH at 25° C. of from 3 to 5, in order to control the degree of reducibility as appropriate such that reduction to cuprous oxide proceeds, but reduction to metallic copper does not proceed, when a reducing compound—in particular a hydrazine compound—is used, and in order to facilitate anisotropic copper crystal growth that proceeds in the second reduction step. In the first reduction step, it is preferable to add the reducing compound after adjusting the pH, in order to control the degree of reduction of copper ions as appropriate.

As long as the effects of the present invention are achieved, the pH can be adjusted by using various acids or basic substances or by causing the polyphosphoric acid substance to be present in the reaction solution. In particular, the use of the polyphosphoric acid substance in the pH adjustment is advantageous in that the subsequent reaction can be caused to occur efficiently without adding other substances to the reaction system, thereby preventing unintended inclusion of impurities and efficiently obtaining the desired copper particles.

The reduction reaction in the first reduction step may be performed with the reaction solution in an unheated state or in a heated state. In either case, the temperature of the reaction solution is preferably from 10° C. to 60° C., more preferably from 20° C. to 50° C. The reaction time in the first reduction step is preferably from 0.1 to 2 hours, more preferably from 0.2 to 1 hour, provided that the temperature is within the aforementioned temperature range. From the viewpoint of uniformity of the reduction reaction, it is also preferable to continue stirring the reaction solution from the start of the reaction to the end of the reaction.

Subsequently, the second reduction step is performed, wherein the cuprous oxide obtained in the first reduction step is reduced, to thereby produce metallic copper particles. It is preferable to perform the second reduction step under wet conditions as with the first reduction step, and it is more preferable to perform both reduction steps in the same reaction system.

As described above, the polyphosphoric acid substance is preferably caused to be present in the reaction system during or before the second reduction step. The polyphosphoric acid substance for use in this manufacturing method may be a polyphosphoric acid, or a salt thereof, having preferably two to eight phosphoric acid monomer units, more preferably two to five phosphoric acid monomer units, in the structure, such as diphosphoric acid (H₄P₂O₇), triphosphoric acid (tripolyphosphoric acid, H₅P₃O₁₀), or tetrapolyphosphoric acid (H₆P₄O₁₃). Examples of polyphosphoric acid salts may include alkali metal salts, alkaline-earth metal salts, other metal salts, ammonium salts, or the like. One of these substances may be used alone, or two or more thereof may be used in combination.

The content of the polyphosphoric acid substance in the second reduction step is preferably 0.1 mmol or greater, more preferably from 0.1 mmol to 1 mol, with respect to 1 mol of copper element. When the concentration of the polyphosphoric acid substance is set within this range, it is possible to facilitate anisotropic copper crystal growth resulting from the reduction reaction of cuprous oxide, and thus manufacture, with high productivity, copper particles with a small particle size and a small crystallite size on a specific crystal plane. Note that, in cases where the polyphosphoric acid substance is added in the first reduction step, since the polyphosphoric acid substance is not consumed in the reaction in the first reduction step and the concentration of the polyphosphoric acid substance substantially does not change before and after the first reduction step, the amount of polyphosphoric acid substance suitable for reduction to metallic copper and grain growth in the second reduction step can be sufficiently achieved by adding the polyphosphoric acid substance to the reaction system in the first reduction step at a concentration within the aforementioned range.

In the second reduction step, the reduction to metallic copper can be caused to occur by adding the aforementioned reducing compound. The content of the reducing compound in the reaction solution in the second reduction step is preferably from 1 to 8 mol, more preferably from 2 to 6 mol, with respect to 1 mol of copper element. In cases where the second reduction step is performed in the same reaction system as that of the first reduction step, it is preferable to further add more reducing compound to the solution such that the content falls within the aforementioned range, from the viewpoint of both improving the reducibility and controlling impurity suppression. It is also preferable to use the same type of reducing compound in the reduction steps.

By controlling the concentration of the reducing compound to fall within this range, it is possible to sufficiently facilitate the reduction reaction to metallic copper, and thus manufacture, with high productivity, copper particles with a small particle size and a small crystallite size on a specific crystal plane.

The reducing compound in the second reduction step may be added in a batch or sequentially. From the viewpoint of efficiently obtaining copper particles that satisfy the crystallite size ratio and particle size mentioned above, sequential addition is preferred.

The reaction solution in the second reduction step is preferably non-acidic (neutral or alkaline) with a pH at 25° C. of 7.0 or greater, in order to cause the copper ions and cuprous oxide remaining in the reaction solution to be efficiently reduced to metallic copper when a reducing compound—in particular a hydrazine compound—is used, and in order to facilitate anisotropic copper crystal growth. It is preferable to adjust the pH before adding the reducing compound in the second reduction step, in order to control the degree of reduction of copper ions as appropriate. The pH can be adjusted by using various acids or basic substances.

In cases where the second reduction step is performed in the same reaction system as that of the first reduction step, since the reaction solution after the first reduction step is acidic, it is preferable to adjust the pH of the reaction solution by adding a basic substance such as sodium hydroxide or potassium hydroxide. In the second reduction step, it is preferable to add the reducing compound after adjusting the pH, in order to efficiently reduce copper ions and cuprous oxide to metallic copper.

From the viewpoint of efficiently facilitating the reduction of copper ions and cuprous oxide in the reaction solution and obtaining copper particles with a predetermined crystallite size with high productivity, it is preferable to heat the reaction solution in the second reduction step. It is preferable to heat the reaction solution such that the temperature is maintained within a range from 10° C. to 60° C., particularly from 20° C. to 50° C., from the start of the second reduction step, that is, from when the reducing compound is added, to the end of the reaction. The reaction time is preferably from 30 to 720 minutes under the aforementioned temperature conditions. It is also preferable to continue stirring the reaction solution from the start of the reaction to the end of the reaction from the viewpoint of causing the reduction reaction to occur uniformly and obtaining copper particles with a small variation in particle size.

The present Inventors infer as follows as to why, in this manufacturing method, it is possible to obtain copper particles having a low sintering temperature by performing reduction in two stages, wherein copper ions are first reduced to cuprous oxide and then to metallic copper, and by causing a polyphosphoric acid substance to be present during the second reduction step.

First, in the first reduction step, copper ions are reduced by the reducing compound in the reaction solution, and very small particles of cuprous oxide are formed in the reaction solution. Then, in the second reduction step, monovalent copper ions eluted from the cuprous oxide particles are reduced to form metallic copper nuclei. Since these nuclei are highly unstable, they repeatedly coalesce with each other or re-dissolve in the reaction solution, and the particles eventually grow. By including the polyphosphoric acid substance during this particle growth, the polyphosphoric acid substance adsorbs onto a specific crystal plane of copper and inhibits growth in the direction of that crystal plane. On the other hand, growth is not inhibited on a crystal plane where the polyphosphoric acid substance is not adsorbed, and the growth proceeds in the direction of that crystal plane.

Based on the fact that metallic copper tends to have a face-centered cubic crystal structure and from the results of X-ray diffraction measurements of the copper particles obtained, the crystal plane where the polyphosphoric acid substance is adsorbed is estimated to be the (111) plane of copper in the particles, and the crystal plane where the polyphosphoric acid substance is not adsorbed is estimated to be the (220) plane of copper, which is perpendicular to the (111) plane of copper. Accordingly, it is conceivable that anisotropic growth occurs in which the growth on the (111) plane of copper is suppressed whereas the growth on the (220) plane of copper proceeds, resulting in flat copper particles having a low sintering temperature.

As a suitable method for manufacturing the copper particles B, by causing the reduction reaction to occur under acidic conditions particularly in the first reduction step, the reduction power can be controlled to the extent that copper ions can be reduced to cuprous oxide, but not to metallic copper. In addition to this, the subsequent metallic copper formation reaction can be easily controlled. Then, the subsequent non-acidic conditions can lower the eluting rate of cuprous oxide and thereby control the supply of monovalent copper ions. By causing the second reduction to occur in such an environment, the rate of reduction to metallic copper can be adjusted to moderate conditions, thus controlling the nucleation growth rate, which is particularly advantageous.

The copper particles B obtained through the aforementioned steps will satisfy the aforementioned suitable crystallite size and ratio, suitable particle size, and suitable content of various elements such as carbon elements, and will also have a flat shape, even without the inclusion of organic components for controlling crystal growth, such as organic amines, amino alcohols, and reducing sugars.

Furthermore, the thus-obtained copper particles B have crystal planes that are present on the principal face and where the crystal has grown in the direction orthogonal to the principal face, as well as crystal planes that are present on the side face and where the crystal has grown in the direction parallel to the principal face, each crystal plane having a specific direction of orientation and being uniformly formed in one direction. Therefore, when the copper powder containing these copper particles B is sintered in a state in which the principal faces of the copper particles B are in contact with each other or in which the side faces of the copper particles B are in contact with each other, excessive energy is not required for fusion because the uniformly aligned identical crystal faces are in contact with each other, and thus, sintering can be performed at a low temperature.

The copper particles B obtained through the aforementioned process may be subjected to washing and solid-liquid separation if necessary, and after that, the copper particles B may be mixed with the copper particles A in the form of a slurry in which they are dispersed in a solvent such as water or an organic solvent, or these particles may be dried and be mixed with the copper particles A in the form of a dry powder, which is an aggregate of the copper particles B. In either case, the copper particles B offer an excellent copper powder having a low sintering temperature. If necessary, the surface of the copper particles B may be further coated with an organic matter, such as a fatty acid or salt thereof, or an inorganic matter, such as a silicon compound, in order to improve dispersion of the particles. Note that, as long as the effects of the present invention are achieved, it is acceptable for the resulting copper particles B to contain elements other than the copper element, such as trace amounts of substances formed through unavoidable oxidation of the surface of the particles.

### Method for Mixing Copper Particles A and Copper Particles B:

The copper particles A and the copper particles B can be mixed according to a dry method or a wet method, but from the viewpoint of convenience of mixing, it is preferable that mixing is performed according to a dry method. Dry mixing can be performed using a known dry mixing device. Wet mixing can be performed, more specifically, by mixing in an organic solvent or aqueous solvent.

The copper powder of the present invention can also be used in the form of a conductive composition, such as a conductive ink or a copper paste, in which the copper particles are further dispersed in an organic solvent, a resin, or the like.

In cases where the copper powder of the present invention is used in the form of a conductive composition, the conductive composition contains at least the copper powder and an organic solvent. As the organic solvent, any organic solvent similar to those conventionally used in the technical field of conductive compositions containing a metal powder can be used without particular limitation. Examples of such organic solvents may include monohydric alcohols, polyhydric alcohols, polyhydric alcohol alkyl ethers, polyhydric alcohol aryl ethers, polyethers, esters, nitrogen-containing heterocyclic compounds, amides, amines, and saturated hydrocarbons. One of these organic solvents may be used alone, or two or more thereof may be used in combination. Among the above, polyethers such as polyethylene glycol and polypropylene glycol are preferably used, in terms that they have a high reducing effect and prevent unintentional oxidation of the copper particles during sintering. For the same reasons, in the case where polyethylene glycol is used as the organic solvent, the number average molecular weight of polyethylene glycol is preferably from 120 to 400, more preferably from 180 to 400.

At least one of a dispersant, an organic vehicle, and a glass frit may be further added to the conductive composition containing the copper powder of the present invention, if necessary. Examples of the dispersant may include dispersants such as nonionic surfactants that do not contain sodium, calcium, phosphorus, sulfur, chlorine, and the like. Examples of the organic vehicle may include mixtures containing a resin component such as an acrylic resin, an epoxy resin, ethyl cellulose, carboxyethyl cellulose, or the like and a solvent such as a terpene-based solvent such as terpineol or dihydroterpineol, an ether-based solvent such as ethyl carbitol or butyl carbitol, or the like. Examples of the glass frit may include borosilicate glass, barium borosilicate glass, and zinc borosilicate glass.

A conductive film containing copper can be formed by applying the conductive composition containing the copper powder of the present invention onto a substrate to form a coating film and firing the coating film. The conductive film can be suitably used, for example, to form a circuit of a printed wiring board or establish electrical continuity of an external electrode of a ceramic capacitor. For example, a printed-circuit board made from a glass epoxy resin etc. or a flexible printed-circuit board made from polyimide etc. can be used as the substrate, depending on the type of electronic circuit in which the copper particles are to be used.

The amounts of the copper powder and the organic solvent to be blended in the conductive composition containing the copper powder of the present invention can be adjusted according to the specific use of the conductive composition and the method for applying the conductive composition, but the copper powder content in the conductive composition is preferably from 5 to 95 mass %, more preferably from 80 to 90 mass %. For example, inkjet printing, dispensing, microdispensing, photogravure printing, screen printing, dip coating, spin coating, spray coating, bar coating, roll coating, and the like can be used as the application method.

It is sufficient that the heating temperature at which the formed coating film is sintered is not lower than the sintering start temperature of the copper powder, and, for example, the heating temperature may be from 150° C. to 220° C. The atmosphere during heating may be, for example, an oxidizing atmosphere or a non-oxidizing atmosphere. An example of the oxidizing atmosphere is an oxygen-containing atmosphere. Examples of the non-oxidizing atmosphere may include a reducing atmosphere such as hydrogen or carbon monoxide, a weakly reducing atmosphere such as a hydrogen-nitrogen mixed atmosphere, and an inert atmosphere such as argon, neon, helium, and nitrogen. Regardless of which atmosphere is used, the heating time is preferably from 1 minute to 3 hours, more preferably from 3 minutes to 2 hours, provided that heating is performed in the aforementioned temperature range.

Since the resulting conductive film is obtained by sintering the copper powder of the present invention, even when sintering is performed at a relatively low temperature, sintering can be proceeded sufficiently. Also, since the copper particles constituting the copper powder will melt even at a low temperature during sintering, the contact area between the copper particles or between the copper particles and the surface of a base material can be increased, and as a result, a sintered structure that has high density and high adhesion to a bonding target can be formed efficiently. Furthermore, the resulting conductive film has high continuity, density and conduction reliability.

The present invention has been described above according to preferred embodiments thereof, but the present invention is not limited to the foregoing embodiments. For example, the copper powder of the present invention may contain copper particles other than the copper particles A and the copper particles B, to the extent that the intended effects of the present invention can be achieved.

The foregoing embodiments of the present invention encompass the following technical ideas.

{1} A copper powder containing copper particles A and copper particles B defined below, wherein:
with respect to a total of the copper particles A and the copper particles B, a content by percentage of the copper particles A is from 60 to 99 mass % and a content by percentage of the copper particles B is from 1 to 40 mass %.

### {Copper Particles A}

The copper particles A are copper particles wherein
each of the copper particles includes a core particle made from copper and a coating layer that coats a surface of the core particle,
the coating layer is formed by a copper salt of an aliphatic organic acid, and a primary particle size is from 0.1 to 0.6 μm.

### {Copper Particles B}

The copper particles B are copper particles wherein
a ratio (S1/B) of a first crystallite size S1 to a BET diameter B is 0.23 or less, the first crystallite size being obtained using Scherrer equation from a full width at half maximum of a peak derived from (111) plane of copper in X-ray diffraction measurement, and the BET diameter B being calculated from a BET specific surface area,
a ratio (S1/S2) of the first crystallite size S1 to a second crystallite size S2 is 1.35 or less, the second crystallite size being obtained using the Scherrer equation from a full width at half maximum of a peak derived from (220) plane of copper in X-ray diffraction measurement, and
a primary particle size is from 0.1 to 2.0 μm.

{2} The copper powder as set forth in clause {1}, wherein
in the copper particles B, a ratio (S1/S3) of the first crystallite size S1 to a third crystallite size S3 is 1.35 or less, the third crystallite size being obtained using the Scherrer equation from a full width at half maximum of a peak derived from (311) plane of copper in X-ray diffraction measurement.

{3} The copper powder as set forth in clause {1} or {2}, wherein
the copper particles B contain a carbon element, and a content of the carbon element is 5000 ppm or less.

{4} The copper powder as set forth in any one of clauses {1} to {3}, wherein
the copper particles B contain a phosphorus element, and a content of the phosphorus element is 300 ppm or greater.

{5} A copper paste containing the copper powder as set forth in any one of clauses {1} to {4}.

{6} A method for manufacturing a conductive film involving:
applying the copper paste as set forth in clause {5} to a base material to form a coating film; and
firing the coating film.

### Examples

Hereinafter, the present invention will be described in greater detail using Examples. However, the scope of the present invention is not limited to the Examples below. Unless particularly stated otherwise, “%” means “mass %”.

In the Examples and Comparative Examples below, copper particles A-1, copper particles A-2, and copper particles B-1 to B-3 were used as copper particles. Among the above, spherical copper particles disclosed in JP 2015-168878A were used as the copper particles A-2.

The other copper particles were manufactured according to the following methods.

### Manufacture of Copper Particles A-1:

A slurry in which spherical core particles (copper: 100 mass %) with no surface treatment agent applied were dispersed in water was manufactured in accordance with the method disclosed in Example 1 of JP 2015-168878A. This slurry was washed by rotary filtering at 25° C. for 30 minutes, and thus, a slurry of washed core particles was obtained. The conductivity after washing was 1.0 mS, and the particles had a spherical shape. The amount of the core particles made of copper contained in the slurry was 1000 g (10 mass %).

Next, the slurry of the washed core particles was heated to 50° C., and in this state, a solution obtained by dissolving 17 g of copper (II) laurate in 4 L of isopropyl alcohol was instantaneously added as a surface treatment agent, and the mixture was stirred at 50° C. for 1 hour. After that, solid-liquid separation was performed by filtration, and thus, copper particles in which a coating layer of a copper salt of an aliphatic organic acid was formed on the surface of the core particles was obtained as the solid part. The amount of the surface treatment agent contained in the obtained copper particles was 0.7 mass % in terms of carbon atoms.

Next, the copper particles A-1 and A-2 were evaluated as follows.

### Measurement of Average Image-Analysis Diameter of Primary Particles:

The average image-analysis diameter of primary particles in the copper particles was measured by the aforementioned method. The results are shown in Table 1 below.

### Calculation of BET Diameter a Based on BET Specific Surface Area:

First, the specific surface area of the copper particles A-1 and A-2 is measured according to the BET single-point method by the aforementioned measurement method, and the BET diameter A was calculated based on the specific surface area. The results are shown in Table 1.

### Evaluation of Temperature at 10% Mass Loss:

In a thermogravimetric analysis when the copper particles were heated from 25° C. to 1000° C., the temperature at which the percentage of the mass loss value became 10% of the mass loss value at 500° C. was measured according to the aforementioned conditions. The results are shown in Table 1.

### Evaluation of Infrared Absorption Peak:

The copper particles A-1 and A-2 were subjected to measurement according to infrared spectroscopy by the aforementioned method. Separately for the range of 1504 to 1514 cm⁻¹ and the range of 1584 to 1596 cm⁻¹, if an infrared absorption peak was observed in the target range, then this was evaluated as “Present”, whereas if no infrared absorption peak was observed in the target range, then this was evaluated as “Absent”. The results are shown in Table 1.

TABLE 1

| | | Copper | Copper |
|---|---|---|---|
| | | particles | particles |
| Copper particles | | A-1 | A-2 |
| Surface treatment agent | Type | Copper(II) | Lauric acid |
| | | laurate | |
| | Amount of | 1.7 | 1.3 |
| | addition in | | |
| | terms of | | |
| | carbon atoms | | |
| | [%] | | |
| BET diameter A [μm] | | 0.21 | 0.22 |
| Average image-analysis diameter of primary | | 0.18 | 0.19 |
| particles (primary particle size) [μm] | | | |
| Presence/absence of infrared | 1504 to 1514 cm⁻¹ | Present | Present |
| absorption peak | 1584 to 1596 cm⁻¹ | Absent | Present |

| | | |
|---|---|---|
| Temperature at 10% mass loss [° C.] | 187 | 246 |

### Manufacture of Copper Particles B-1:

### First Reduction Step:

In a stainless steel tank containing 5.0 liters of warm pure water and 5.0 liters of methanol were placed 2.5 kg of copper acetate monohydrate as a copper source and 8.0 g of sodium tripolyphosphate as a polyphosphoric acid substance (with a molar ratio of 0.002 with respect to 1 mol of copper element), and stirring was performed at a liquid temperature of 25° C. for 30 minutes so that these substances were dissolved.

Then, 235.0 g of hydrazine (with a molar ratio of 1.55 with respect to 1 mol of copper element) was added to the solution, and stirring was continued at a liquid temperature of 25° C. for 30 minutes without heating, to produce fine particles of cuprous oxide in the solution. After the production of cuprous oxide, the reaction solution was stirred for 30 minutes.

### Second Reduction Step:

Subsequently, the pH of the solution was adjusted to 7.0 by adding 25% NaOH aqueous solution to the reaction solution in the first reduction step. The temperature of the liquid was then heated to 40° C., and 1900.0 g of hydrazine (with a molar ratio of 3.0 with respect to 1 mol of copper element) was quantitatively and successively added to the liquid over 10 minutes to perform the second reduction step. The temperature of the liquid was then cooled to 30° C., and stirring was continued over 150 minutes, to obtain copper particles in which the fine particles of cuprous oxide were reduced to metallic copper.

Decantation washing was performed on the resulting aqueous slurry of copper particles until the conductivity reached 1.0 mS (washed slurry).

The slurry of the washed core particles was heated to 50° C., and in this state, a solution obtained by dissolving 4 g of copper (II) laurate in 1 L of isopropyl alcohol was instantaneously added as a surface treatment agent, and the mixture was stirred at 50° C. for 1 hour. After that, solid-liquid separation was performed by filtration, and thus, copper particles having a coating layer of a copper salt of an aliphatic organic acid formed on the surface of the core particles were obtained as the solid part. The solid part was then dried, to obtain a copper powder constituted by an aggregate of the copper particles. The obtained copper particles had a copper element content of more than 98 mass % and a flat shape.

### Manufacture of Copper Particles B-2:

Copper particles B-2 were obtained according to the same manufacturing method as that for the copper particles B-1, except that the amount of addition of sodium tripolyphosphate was changed to 24 g (with a molar ratio of 0.006 with respect to 1 mol of copper element). The obtained copper particles had a copper element content of more than 98 mass % and a flat shape.

### Manufacture of Copper Particles B-3:

4 kg of copper sulfate pentahydrate and 120 g of aminoacetic acid were dissolved in water, to prepare 8 L of an aqueous copper salt solution at a liquid temperature of 70° C. Then, while stirring the solution, 6.6 kg of 25 mass % sodium hydroxide solution was added at a constant rate over about 5 minutes. Then, the solution was stirred at a liquid temperature of 70° C. for 60 minutes and aged until the liquid color turned completely black, to produce cupric oxide. The solution was then allowed to stand for 30 minutes, and 1.5 kg of glucose was added to reduce the cupric oxide to cuprous oxide through aging for 1 hour. Furthermore, 1 kg of hydrazine hydrate was added quantitatively over 5 minutes to reduce the cuprous oxide to metallic copper, to produce a copper powder slurry. The obtained copper powder slurry was then filtered, washed sufficiently with pure water, filtered again, and then dried. The obtained Cu powder was subjected to plastic deformation by employing the flattening method disclosed in Japanese Patent No. 4227373, to make the substantially spherical copper powder into flat-shaped copper powder. Note that the bead diameter used in this process was not 0.7 mm, but changed to 0.2 mm.

Next, the copper particles B-1 to B-3 were evaluated as follows.

### Measurement of Average Image-Analysis Diameter of Primary Particles:

The average image-analysis diameter of primary particles in the respective copper particles B-1 to B-3 was measured according to the aforementioned method. The results are shown in Table 2.

### Calculation of BET Diameter B Based on BET Specific Surface Area:

The BET diameter B of the respective copper particles B-1 to B-3 was measured by the same method as that for the BET diameter A of the copper particles A. The results are shown in Table 2 below.

### Measurement of Contents of Carbon and Phosphorus Elements:

The content of carbon element in the respective copper particles B-1 to B-3 was measured by placing 0.50 g of one of the copper particles B-1 to B-3 in a magnetic crucible and performing measurement using a carbon/sulfur analyzer (CS844 manufactured by LECO Japan Corporation) by employing oxygen gas (with a purity of 99.5%) as the carrier gas and setting the analysis time to 40 seconds. The measurement results are shown in Table 2 below.

The content of phosphorus element in the copper particles was measured by introducing a solution obtained by dissolving 1.00 g of one of the copper particles B-1 to B-3 in 50 mL of 15% nitric acid aqueous solution, into an ICP optical emission spectrometer (PS3520VDDII manufactured by Hitachi High-Tech Science Corporation). The measurement results are shown in Table 2 below.

### Measurement of Crystallite Size:

The copper particles B-1 to B-3 were measured using the following method. First, a 20 mass % aqueous slurry was prepared using the washed slurry of one of the copper particles B-1 to B-3. Then, an isopropyl alcohol solution obtained by dissolving 12 g of copper laurate as a surface coating treatment agent was added at once to the slurry heated to 50° C., and stirred for 1 hour. Then, the solid part obtained through solid-liquid separation by filtration was vacuum-dried, to obtain copper particles with surface coating treatment. The copper powder was classified using a sieve with a 75 μm mesh opening, and the portion under the sieve was used as the sample. The sample was filled into a sample holder and measured using an X-ray diffractometer (Ultima IV manufactured by Rigaku Corporation) under the following conditions.

Then, among the diffraction peaks, the main peak at the position corresponding to the (220), (111) or (311) plane of copper was measured, and the crystallite sizes S1 to S3 and the ratios S1/S2 and S1/S3 were calculated using the Scherrer equation mentioned above from the full width at half maximum of the peak. The S1/B ratio was also calculated from the obtained crystallite sizes. The results are shown in Table 2 below.

### X-Ray Diffraction Measurement Conditions:

Tube: CuKα ray
Tube voltage: 40 kV
Tube current: 50 mA
Measurement diffraction angle: 2θ=20 to 100°
Measurement step width: 0.01°
Collection time: 3 sec/step
Receiving slit width: 0.3 mm
Divergence vertical limit slit width: 10 mm
Detector: High-speed 1D X-ray detector D/teX Ultra250

### Method for Preparing Sample for X-Ray Diffraction:

The copper powder to be measured was laid on a measurement holder and smoothed with a glass plate so that the copper powder was 0.5 mm thick and smooth.

The X-ray diffraction patterns obtained under the measurement conditions described above were analyzed using analytical software under the following conditions. In the analysis, correction of peak width was performed using LaB6 values. The crystallite size was calculated using the full width at half maximum of the peak and Scherrer's constant (0.94).

### Analysis Conditions for Measurement Data:

Analytical software: PDXL2 manufactured by Rigaku
Smoothing: Gaussian function, smoothing parameter=10
Background removal: Fitting method
Kα2 removal: Intensity ratio 0.497
Peak search: Second derivative method
Profile fitting: FP method
Crystallite size distribution type: Lorentz model
Scherrer's constant: 0.9400

The peaks of the X-ray diffraction patterns used in the analysis are shown below. The Miller indices shown below are synonymous with the copper crystal planes described above.
Peak indexed by Miller Indices (220) around 2θ=71° to 76°.
Peak indexed by Miller Indices (111) around 2θ=40° to 45°.
Peak indexed by Miller Indices (311) around 2θ=87.5° to 92.5°.

TABLE 2

| | Copper | Copper | Copper |
|---|---|---|---|
| | particles | particles | particles |
| Copper particles | B-1 | B-2 | B-3 |
| BET diameter B [μm] | 0.24 | 0.35 | 0.28 |
| Average image-analysis diameter | 0.32 | 0.44 | 0.42 |
| of primary particles [μm] | | | |
| (111) plane crystallite size S1 [nm] | 35 | 32.8 | 28.8 |
| (220) plane crystallite size S2 [nm] | 34.3 | 29.6 | 18 |
| (311) plane crystallite size S3 [nm] | 30.4 | 30.4 | 12.9 |
| S1/B ratio | 0.14 | 0.09 | 0.10 |
| S1/S2 ratio | 1.02 | 1.11 | 1.60 |
| S1/S3 ratio | 1.15 | 1.08 | 2.23 |
| Carbon element content [ppm] | 4000 | 2700 | 2000 |
| Phosphorus element content [ppm] | 335 | 360 | <10 |

### Examples 1 to 7 and 9, and Comparative Examples 1 to 7

The copper particles A-1, A-2, and B-1 to B-3 were mixed according to the ratios shown in Table 3 below, to obtain the respective copper powders of the Examples and Comparative Examples. More specifically, the copper particles were placed in a 100-mL container according to the respective ratios shown in Table 3, and were then mixed using a compact ball mill (AV-1 manufactured by Asahi Rika Seikakusho Co., Ltd.), to obtain the respective copper powders of the Examples and Comparative Examples. Mixing was performed at 100 rpm for 1 hour.

The respective copper powder obtained as described above was mixed with polyethylene glycol (number-average molecular weight: 200) using a three-roll mill, to produce a copper paste containing 85 mass % of the copper powder.

Note that Table 3 shows the contents of the respective copper particle components with respect to a total of 100 parts by mass of the copper particles. “Solid part concentration” refers to the percentage by mass of the copper powder to the mass of the entire copper paste.

### Evaluation of Paste Printability:

The printability of the respective pastes of the Examples and Comparative Examples was evaluated according to the following evaluation criteria.

### Criteria for Evaluating Paste Printability:

Pass: Applicable onto a glass plate masked to a size of 2 cm in length and 1 cm in width.

Fail: Film having continuity could not be formed under the aforementioned conditions.

### Manufacture of Conductive Film:

The respective copper paste of the Examples and Comparative Examples was applied onto a glass substrate, and the substrate was fired in a nitrogen atmosphere at 190° C. for 10 minutes, to form a conductive film on the glass substrate.

Each of the obtained conductive films was 2 cm long, 1 cm wide, and 30 μm thick. The conductive films were evaluated as follows.

### Evaluation of Film Production Strength:

The strength of the produced conductive films was evaluated according to the following evaluation criteria.

### Criteria for Evaluating Film Production Strength:

High: No powder adhered to the hand when the surface of the conductive film was scratched.
Low: Powder adhered to the hand when the surface of the conductive film was scratched.

### Measurement of Resistivity of Conductive Film:

The resistivity of each conductive film was measured using a resistivity meter (Loresta-GP MCP-T610, manufactured by Mitsubishi Chemical Analytech Co., Ltd.). The measurement was performed three times for each conductive film to be measured, and the arithmetic mean value of the measured values was used as the resistivity (μΩ·cm) of that conductive film. The lower the resistivity, the lower the resistance of the conductive film, and the resistivity is preferably 50 μΩ·cm or less. The results are shown in Table 3 below.

### Evaluation of Thickness of Conductive Film:

The thickness of the fired film of the Cu paste was found by measuring the thickness of the conductive film and the glass substrate and the thickness of only the glass substrate by using a digital length measuring system (MFC-101 manufactured by Nikon Corporation) and finding the difference between these thicknesses as the thickness of the conductive film.

### Measurement of Surface Roughness Ra of Conductive Film:

The surface roughness (average roughness Ra) of each conductive film was found by performing measurement at three sites on each conductive film by using a surface texture/contour measuring system (SURFCOM 130A manufactured by Tokyo Seimitsu Co., Ltd.) and calculating the average value from the measurement values. The results are shown in Table 3.

From the viewpoint of electrical resistance, it is preferable that the surface roughness Ra is 2.0 or less. A small conductive-film surface roughness Ra indicates that the density of the conductive film is high.

### Measurement of Joint Strength:

A 5-mm square copper chip, with one surface polished with a #800 abrasive sheet, was prepared, and the copper paste was screen printed onto the chip's polished side into a 2 mm×2 mm×30 μm shape. Then, a 3-mm square copper chip, with one surface polished with a #800 abrasive sheet, was placed thereon such that the polished surface was the joining surface. Then, the sheets were joined using a pressure firing device (IMC-1AB6 manufactured by Imoto Machinery Co., Ltd.) by performing firing in a nitrogen atmosphere at 200° C. for 30 minutes while applying pressure at 5 MPa. The joint strength of the obtained joined body was measured by using a bond tester (Condor Sigma from XYZTEC).

The aforementioned measurement was performed three times, and the average value and the maximum value of the joint strength were calculated. These values are shown in Table 3. In Table 3, the joint strength is shown as a value normalized such that the joint strength of Comparative Example 3 is 1.0. In Table 3, “−” indicates that measurement was not performed.

TABLE 3

| | Composition of copper paste | | | | | |
|---|---|---|---|---|---|---|
| | Copper | Copper | Copper | Copper | Copper | Solid part |
| | particles A-1 | particles A-2 | particles B-1 | particles B-2 | particles B-3 | concentration |
| | [parts by mass] | [parts by mass] | [parts by mass] | [parts by mass] | [parts by mass] | [%] |
| Example 1 | 85 | 0 | 0 | 15 | 0 | 85 |
| Example 2 | 80 | 0 | 0 | 20 | 0 | 85 |
| Example 3 | 75 | 0 | 0 | 25 | 0 | 85 |
| Example 4 | 70 | 0 | 0 | 30 | 0 | 85 |
| Example 5 | 60 | 0 | 0 | 40 | 0 | 85 |
| Example 6 | 80 | 0 | 20 | 0 | 0 | 85 |
| Example 7 | 60 | 0 | 40 | 0 | 0 | 85 |
| Example 9 | 95 | 0 | 0 | 5 | 0 | 85 |
| Comparative | 80 | 0 | 0 | 0 | 20 | 85 |
| Example 1 | | | | | | |
| Comparative | 0 | 80 | 0 | 20 | 0 | 85 |
| Example 2 | | | | | | |
| Comparative | 100 | 0 | 0 | 0 | 0 | 85 |
| Example 3 | | | | | | |
| Comparative | 0 | 100 | 0 | 0 | 0 | 85 |
| Example 4 | | | | | | |
| Comparative | 0 | 0 | 100 | 0 | 0 | 85 |
| Example 5 | | | | | | |
| Comparative | 0 | 0 | 0 | 100 | 0 | 85 |
| Example 6 | | | | | | |
| Comparative | 0 | 0 | 0 | 0 | 100 | 85 |
| Example 7 | | | | | | |

| | Evaluation results | | | | | | |
|---|---|---|---|---|---|---|---|
| | | | Thickness of | | | Joint strength | |
| | | Film | conductive | | Surface | (normalized value) | |
| | Paste | production | film | Resistivity | roughness Ra | Maximum | Average |
| | printability | strength | [μm] | [μΩ · cm] | [μm] | value | value |
| Example 1 | Pass | High | 31 | 37 | 1.5 | — | — |
| Example 2 | Pass | High | 29 | 36 | 1.8 | 1.6 | 1.3 |
| Example 3 | Pass | High | 33 | 44 | 1.4 | — | — |
| Example 4 | Pass | High | 26 | 34 | 0.8 | — | — |
| Example 5 | Pass | High | 24 | 32 | 1.9 | — | — |
| Example 6 | Pass | High | 30 | 38 | 0.7 | — | — |
| Example 7 | Pass | High | 24 | 42 | 0.8 | — | — |
| Example 9 | Pass | High | 27 | 20 | — | 1.5 | 1.5 |
| Comparative | Pass | High | 43 | 73917 | 0.9 | — | — |
| Example 1 | | | | | | | |
| Comparative | Pass | Low | 29 | Beyond | Measurement | — | — |
| Example 2 | | | | measurement | not possible | | |
| | | | | upper limit | | | |
| Comparative | Pass | High | 35 | 58 | 4.0 | 1.0 | 1.0 |
| Example 3 | | | | | | | |
| Comparative | Pass | Low | 35 | Beyond | Measurement | — | — |
| Example 4 | | | | measurement | not possible | | |
| | | | | upper limit | | | |
| Comparative | Pass | High | 25 | 170 | 1.1 | — | — |
| Example 5 | | | | | | | |
| Comparative | Pass | High | 26 | 384 | 1.8 | 0.7 | 0.5 |
| Example 6 | | | | | | | |
| Comparative | Pass | Low | 42 | Beyond | Measurement | — | — |
| Example 7 | | | | measurement | not possible | | |
| | | | | upper limit | | | |

As shown in Table 3, the conductive films of the Examples all had a low resistivity, even though they were manufactured by being fired at a relatively low temperature of 190° C. The results show that the copper powders used in the Examples have a low sintering temperature. The results also show that the conductive films of the Examples all have excellent paste printability and small surface roughness Ra, and thus have excellent continuity and density.

Further, a comparison between Example 2 and Comparative Example 1 shows that, even though both examples employ flat copper particles, the use of mechanically flattened copper particles, such as the copper particles B-3, causes an increase in the copper powder's sintering temperature and an increase in the conductive film's resistivity.

### Example 8, Comparative Example 8, and Comparative Example 9

Respective copper pastes and conductive films of Example 8, Comparative Example 8, and Comparative Example 9 were produced in the same manner as in Example 2, Comparative Example 3, and Comparative Example 5, except that, when the respective copper powder was mixed with polyethylene glycol (number-average molecular weight: 200) using a three-roll mill, the mixing ratio of the copper powder and polyethylene glycol was changed to produce a copper paste containing 90 mass % of the copper powder, as shown in Table 4 below. These copper pastes and conductive films thereof were subjected to the same evaluations as those for Examples 1 to 7 and Comparative Examples 1 to 7. The results are shown in Table 4.

TABLE 4

| | Composition of copper paste | | | Evaluation results | | | |
|---|---|---|---|---|---|---|---|
| | Copper | Copper | Solid part | | Film | | Surface |
| | particles A-1 | particles B-1 | concentration | Paste | production | Resistivity | roughness Ra |
| | [parts by mass] | [parts by mass] | [%] | printability | strength | [μΩ · cm] | [μm] |
| Example 2 | 80 | 20 | 85 | Pass | High | 36 | 1.8 |
| Example 8 | 80 | 20 | 90 | Pass | High | 33 | 2.6 |
| Comparative | 100 | 0 | 85 | Pass | High | 58 | 4.0 |
| Example 3 | | | | | | | |
| Comparative | 100 | 0 | 90 | Pass | High | 825 | 3.5 |
| Example 8 | | | | | | | |
| Comparative | 0 | 100 | 85 | Pass | High | 170 | 1.1 |
| Example 5 | | | | | | | |
| Comparative | 0 | 100 | 90 | Pass | High | Beyond | 3.1 |
| Example 9 | | | | | | measurement | |
| | | | | | | upper limit | |

As shown in Table 4, the copper powders of Examples 2 and 8, which contained both the copper particles A-1 and B-1, were less likely to be negatively affected in terms of the conductive film's resistivity and surface roughness Ra, even when the content of the organic solvent in the copper paste was changed. In contrast, in cases where a copper powder containing only either one of the copper particles A-1 and B-1 was used as in Comparative Examples 8 and 9, the results show that, when the content of the organic solvent in the copper paste was changed to 10 mass %, particularly the conductive film's resistivity increased significantly.

### INDUSTRIAL APPLICABILITY

The invention provides a copper powder having a low sintering temperature and capable of manufacturing a conductive film having high continuity and density.

1. A copper powder comprising copper particles A and copper particles B defined below, wherein:
with respect to a total of the copper particles A and the copper particles B, a content by percentage of the copper particles A is from 60 to 99 mass % and a content by percentage of the copper particles B is from 1 to 40 mass %;
the copper particles A are copper particles wherein
each of the copper particles includes a core particle made from copper and a coating layer that coats a surface of the core particle,
the coating layer is formed by a copper salt of an aliphatic organic acid, and
a primary particle size is from 0.1 to 0.6 μm; and
the copper particles B are copper particles wherein
a ratio (S1/B) of a first crystallite size S1 to a BET diameter B is 0.23 or less, the first crystallite size being obtained using Scherrer equation from a full width at half maximum of a peak derived from (111) plane of copper in X-ray diffraction measurement, and the BET diameter B being calculated from a BET specific surface area,
a ratio (S1/S2) of the first crystallite size S1 to a second crystallite size S2 is 1.35 or less, the second crystallite size being obtained using the Scherrer equation from a full width at half maximum of a peak derived from (220) plane of copper in X-ray diffraction measurement, and
a primary particle size is from 0.1 to 2.0 μm.

2. The copper powder according to claim 1, wherein
in the copper particles B, a ratio (S1/S3) of the first crystallite size S1 to a third crystallite size S3 is 1.35 or less, the third crystallite size being obtained using the Scherrer equation from a full width at half maximum of a peak derived from (311) plane of copper in X-ray diffraction measurement.

3. The copper powder according to claim 1, wherein
the copper particles B contain a carbon element, and a content of the carbon element is 5000 ppm or less.

4. The copper powder according to claim 1, wherein
the copper particles B contain a phosphorus element, and a content of the phosphorus element is 300 ppm or greater.

5. A copper paste comprising the copper powder according to claim 1.

6. A method for manufacturing a conductive film, comprising:
applying the copper paste according to claim 5 to a base material to form a coating film; and
firing the coating film.
